(19) United States
(12) Patent Application Publication
(10) Pub. No.: US 2012/0268692 A1
(43) Pub. Date: Oct. 25, 2012

(54) LIQUID CRYSTAL OPTICAL DEVICE AND ITS PRODUCTION PROCESS

(75) Inventors: Remi KAWAKAMI, Chiyoda-ku (JP); Satoshi NIIYAMA, Chiyoda-ku (JP); Yutaka NAKAGAWA, Arakawa-ku (JP); Yuji SODA, Arakawa-ku (JP)

(73) Assignees: OPTREX Corporation, Arakawa-ku (JP); ASAHI GLASS COMPANY, LIMITED, Chiyoda-ku (JP)

(21) Appl. No.: 13/267,358

(22) Filed: Oct. 6, 2011

(30) Foreign Application Priority Data
Apr. 7, 2011 (JP) 2011-085518

(51) Int. Cl. G02F 1/1337; H01J 9/24; G02F 1/1335

(52) U.S. Cl. 349/96; 349/123; 445/24

(57) ABSTRACT

A liquid crystal optical device comprising a pair of substrates having an electrode pair formed; a liquid crystal layer sandwiched between the substrates; an alignment layer to align the liquid crystal, provided on each of the facing surfaces of the substrates; and a polymer structure provided on the alignment layer; wherein the polymer structure is formed by curing a curable compound represented by the following formula (1), and when a voltage is not applied, liquid crystal molecules in the vicinity of an interface between the liquid crystal layer and the polymer structure have at least one direction of director different from the alignment direction by the alignment layer:

A¹-O—R¹—O—Z—O—R²—O-A² Formula (1)

wherein each of A¹ and A² is independently a curable functional group to be polymerized by an external energy, each of R¹ and R² is independently selected from a linear alkylene group with carbon number of 2 to 5 which may have a methyl group or an ethyl group as a branched chain, and Z is a bivalent mesogen structure.

### BACKGROUND OF INVENTION

1. Field of Invention

The present invention relates to a liquid crystal optical device of which the transmission state is controlled depending on the application of a voltage, such as a liquid crystal optical shutter, a liquid crystal light control device or a liquid crystal display device, and its production process.

2. Discussion of Background

A liquid crystal optical device has established a firm position as a display device for a display of e.g. a TV, a personal computer and a car navigation system. Further, its application to a light control device has also been attempted. A liquid crystal optical device usually has a structure in which a liquid crystal layer is sandwiched between a pair of substrates. As one method of forming a liquid crystal layer, attention has been paid to a method of injecting a liquid crystal composition containing liquid crystal and a curable compound to between a pair of substrates, and subjecting the curable compound to curing treatment after injection and leading to phase-separation of the liquid crystal and the polymer, or a method of forming a liquid crystal layer by a gel comprising the liquid crystal and the polymer, and extensive research and development have been conducted.

As a liquid crystal optical device which is employing liquid crystal and a polymer, showing a transparent and scattering state according to its applied voltage,has been known. This optical change is induced by a difference of refractive indices between the polymer and the liquid crystal or a difference of refractive indices between the each liquid crystal domain, and is called e.g. a liquid crystal/polymer composite device, a liquid crystal/resin composite device or a polymer dispersed liquid crystal device. This liquid crystal optical device has such excellent advantages that since it requires no polarizer in principle, the light absorption loss is small, and a high scattering performance can be obtained, whereby the light utilization efficiency is high. By making use of such properties, it is applied to light control glass, an optical shutter, a laser device, a display device, etc. An optical device which shows a scattering state when a voltage is not applied and shows a transparent state when a voltage is applied, is widely commercialized, and other optical device which shows a transparent state when a voltage is not applied (reverse mode) has also been proposed.

For example, Patent Document 1 discloses a transparent-scattering type liquid crystal optical device called PSCT (Polymer Stabilized Cholesteric Texture). Specifically, a small amount of polymers are dispersed in a chiral nematic liquid crystal showing selective reflection of infrared light. When a voltage is not applied, the chiral nematic liquid crystal shows selective reflection of infrared light, which is a transparent state to visible light wavelength region, by its planar alignment state stabilized by the polymer. On the other hand, helical axes of the each chiral nematic liquid crystal changed to an oblique direction randomly from the normal direction to the surface of substrate, i.e. to a focal conic state, thereby to show a scattering state.

Further, the present applicant has proposed a liquid crystal optical device wherein a liquid crystal/cured material composite layer is formed by a liquid crystal composition comprising a curable compound of the following formula (A) and liquid crystal (Patent Document 2).

A₁-(OR₁)ₙ —O—Z—O—(R₂O)ₘ-A₂ Formula (A)

wherein each of A₁ and A₂, is independently any one of an acryloyl group, a methacryloyl group, a glycidyl group or an allyl group, each of R₁ and R₂, is independently selected from a alkylene group with carbon number of 2 to 5(C₂₋₅ in other words), Z is a bivalent mesogen structure group, and each of n and m, is independently an integer of from 1 to 10. It is reported that by forming a liquid crystal/cured material composite layer by using a curable compound of the above formula (A), a transparent state when a voltage is not applied, and a high reliability and a high contrast can be realized.

In the above two prior art documents, a polymer has an important role in order to stably maintain or fix the liquid crystal alignment when a voltage is not applied. The technique to stabilize or control the liquid crystal alignment by such a polymer is not limited to the above-described transparent-scattering type optical device, and research and development are in progress for various liquid crystal optical devices.

Patent Document 3 reports, as a technique for giving wide viewing angle characteristic to a TN mode liquid crystal display device, a method of axisymmetrically aligning liquid crystal in a liquid crystal layer divided by polymer walls. When a voltage is applied, the alignment of the liquid crystal is changed to be axisymmetrically along polymer walls, whereby the difference of refractive indices among the viewing angles is suppressed, and accordingly a wide viewing angle is realized. Such a liquid crystal display device is called ASM (Axially Symmetrically aligned Microcell) mode.

The above is a technique to impart an effect of e.g. fixing the alignment or dividing the domain of liquid crystal in a liquid crystal optical device by adding a relatively large amount, for example, at least several tens of mass %, of a curable compound to form a structure such as a polymer wall.

Wheareas, Patent Documents 4 and 5 propose liquid crystal display devices such that by using a liquid crystal composition containing a very small amount at a level of several mass % of a curable compound, the curable compound is polymerized while applying a voltage, thereby to regulate the alignment direction of liquid crystal when a voltage is not applied and the alignment change direction when a voltage is applied.

The above Patent Document 4 relates to a MVA (Multidomain Vertical Alignment) mode liquid crystal display device. This technique is to produce the device by injecting a liquid crystal composition containing a curable compound having at least one ring structure or condensed ring structure and two functional groups directly bonded thereto, and a liquid crystal having a negative dielectric anisotropy, into a cell, followed by irradiation with ultraviolet(UV) light while applying a voltage. By the above process, a polymer structure is formed at a uppermost layer of substrate, and the alignment change direction of the liquid crystal when a voltage is applied is memorized, thereby to provide a liquid crystal display device having an improved response speed. As a preferred example of the curable compound, a compound of the formula (B) is disclosed.

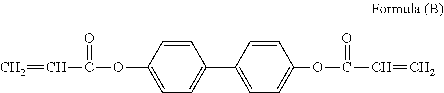

The above Patent Document 5 proposes a method of using a photosensitive monomer which has an in-plane condensed ring structure as hard core structure of the following formula (C) as a curable compound having an effect of high curing property, an effect of high controllability for the liquid crystal alignment, and an effect of reliability, in the technique to control the alignment of liquid crystal by a polymer.

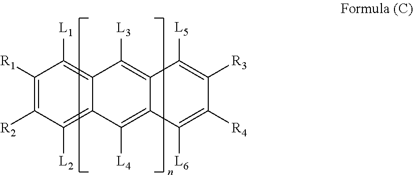

In the formula (C), each of L₁, L₂, L₃, L₄, L₅ and L₆ is hydrogen, fluorine, chlorine, a cyano group, a C₁₋₇ alkyl group of which at least one hydrogen atom may be substituted by fluorine or chlorine, an alkylcarbonyl group or an alkylcarbonyloxy group. Each of R₁, R₂, R₃ and R₄ is one selected from hydrogen, fluorine, chlorine, a cyano group, a thiocyanate group, a pentafluorosulfanyl group, a nitrite group, a linear alkyl group, a branched alkyl group and a Z-Sp-P group. At least one of R₁, R₂, R₃ and R₄ is Z-Sp-P. Z is selected from O, S, a methoxy group, a carbonyl group, a carboxy group, a carbamoyl group, a methylthio group, an ethenylcarbonyl group, a carbonylethenyl group and a single bond. Sp is selected from a linear alkyl group, a branched alkyl group and a single bond. P is a polymerizable group.

Further, Patent Document 6 proposes a liquid crystal display device having a polymer structure which imparts a tilted vertical alignment effect to liquid crystal when a voltage is not applied, by applying a photosensitive monomer which has an in-plane condensed ring structure as hard core structure, on the electrode of substrate and polymerizing the photosensitive monomer while applying a magnetic field.

The production process disclosed in the above Patent Document 6 is as follows. First, a layer comprising a liquid crystalline monomer, and having a property to align the liquid crystalline vertically to an interface of other materials and a property to polymerize, is formed on a substrate. Then, a magnetic field is applied in liquid crystal state, and the liquid crystalline structure of the liquid crystalline monomer is aligned to a direction slightly tilted from the normal direction of the substrate. In this state, the liquid crystalline monomer is polymerized to form, as a vertical alignment layer, a cured layer of the liquid crystalline monomer. Then, two transparent substrates are disposed so that the vertical alignment layers face each other, and liquid crystal is injected into the space to obtain a liquid crystal display device having the vertical alignment layer.

Those techniques, regulating the alignment of liquid crystal molecules by a polymer structure composed of a liquid crystalline curable compound, is applicable to a liquid crystal display device of not only a vertical alignment mode but also a horizontal alignment mode such as TN mode, IPS mode, ECB (Electrically Controlled Birefringence) mode and OCB (Optically Compensated Bend) mode.

Patent Document 7 discloses the following process for producing an alignment layer by a polymer structure applicable to a liquid crystal display device of a horizontal alignment mode. A silane coupler layer is formed on an ITO substrate, and solution of a liquid crystalline curable compound diluted with an organic solvent is applied thereon and air dried, and then polymerized by irradiation with ultraviolet rays while applying a magnetic field to obtain a horizontal alignment layer having a pretilt angle. It has been reported that an effect of controlling the alignment by the polymer structure in the liquid crystal cell using a substrate having the above horizontal alignment layer was confirmed.

Patent Document 1: WO1992/19695

Patent Document 2: U.S. Pat. No. 6,723,393

Patent Document 3: Japanese Patent No. 2,933,816

Patent Document 4: U.S. Pat. No. 7,169,449

Patent Document 5: U.S. Pat. No. 7,820,070

Patent Document 6: JP-A-2009-139455

Patent Document 7: Japanese Patent No. 3,572,787

For a liquid crystal optical device wherein a polymer structure is formed on a substrate by a curable compound thereby to control the alignment direction of liquid crystal, polymerization properties of the curable compound and properties of a resin after polymerization are important to secure a reliability of the liquid crystal optical device. After curing of the curable compound, in case that the amount of the unreacted curable compound remaining in a liquid crystal layer is large, a optical properties of the liquid crystal optical device are greatly affected, such that holding of the liquid crystal alignment might become unstable over time. Further, in a case a shape stability of the polymer structure is poor, the optical properties of the liquid crystal optical device are greatly affected in the same manner. Accordingly, for a liquid crystal optical device wherein a polymer structure of a small amount of curable compound is formed to regulate a direction of liquid crystal alignment, the curable compound having high reliability has been desired.

The above Patent Document 4 discloses that by using the curable compound having at least one ring structure or condensed ring structure and two functional groups directly bonded thereto, such as a compound of the above formula (B), an image sticking (a phenomenon such that after the same image is displayed for a long time, the previous image with a low contrast ratio remains in the next image) can be remarkably reduced. However, further reduction of the image sticking has been required to provide a high reliability of a liquid crystal optical device to meet the needs for high quality and high image quality.

In the above Patent Document 5 also, there is a problem in view of a reliability. With an aromatic condensed ring compound such as a curable compound of the formula (C), a absorption coefficient in a ultraviolet region and in a short wavelength visible region may increase as the number of rings increases. That is, by an increase in the absorption coefficient in the ultraviolet region and in the short wavelength visible region, deterioration or decomposition of the liquid crystal may occur by the incident light, thus leading to a decrease of a resistivity and a decrease of a voltage holding ratio, and thus the reliability of the liquid crystal optical device may be decreased.

In the above Patent Document 6, a liquid crystalline monomer is polymerized before bonding a pair of substrates, and accordingly it is expected that the problem of an unreacted monomer remaining in the liquid crystal layer can be prevented. However, since the liquid crystalline monomer is mono-functional and the counter end of molecule is a long alkyl chain, a polymer of the liquid crystalline monomer shows a thermoplastic property, or it is difficult to sufficiently increase a elastic modulus of the polymer in some cases. Accordingly, the alignment direction of liquid crystal molecules might not be stabilized in a wide temperature range, or a stability of the regulation of liquid crystal alignment might be impaired over time.

### SUMMARY OF INVENTION

The present invention has been made under the above circumstances, and its object is to provide a highly reliable liquid crystal optical device, and its production process.

The liquid crystal optical device of the present invention comprises a pair of substrates with electrodes and at least one of the substrates is transparent, a liquid crystal layer sandwiched between the substrates; an alignment layer to align the liquid crystal, provided on each of the facing surfaces of the substrates; and a polymer structure provided on each alignment layer. The polymer structure is formed by curing a curable compound represented by the following formula (1) while a voltage is applied, and when a voltage is not applied, liquid crystal molecules in the vicinity of an interface between the liquid crystal layer and the polymer structure have at least one direction of a director different from the alignment direction by the alignment layer.

A¹-O—R¹—O—Z—O—R²—O-A² Formula (1)

wherein each of A¹ and A² is independently a curable functional group to be polymerized by an external energy, each of R¹ and R² is independently selected from a linear alkylene group with carbon number of 2 to 5 which may have a methyl group or an ethyl group as a branched chain, and Z is a bivalent mesogen structure.

According to the liquid crystal optical device of the present invention, a molecular motion (such as rotational, translational and vibrational motion) of a curable moiety can be improved by introducing favorable length alkylene group (R¹ and R²) between the mesogen structure and each of the curable functional group (A¹ and A²) by means of an O atom in the curable compound. As a result, the curable compound can be cured by a low irradiation energy for adequate curing. Further, since the molecular motion of the curable moiety during the curing is improved to increase the curing reactivity of the curable compound, the amount of the residual uncured curable compound in the liquid crystal layer can be reduced. Further, by using the curable compound of the above formula (1), after curing, the thermoplastic property of a cured material can be suppressed. As a result, a polymer structure showing elastic deformation can be obtained. Accordingly, the liquid crystal optical device excellent in the reliability can be provided.

The process for producing the liquid crystal optical device of the present invention comprises a step of forming an alignment layer to align liquid crystal on each electrode of a pair of substrates; a step of bonding the substrates each having the alignment layer formed and supplying a liquid crystal composition comprising a liquid crystal and a curable compound represented by the following formula (1) between the substrates; and a step of applying an external energy to carry out the curing reaction of the curable compound while a voltage is applied to control the alignment of liquid crystal composition to be in a desired direction, thereby to form a polymer structure on each alignment layer. In the above described liquid crystal optical device, when a voltage is not applied, liquid crystal molecules in the vicinity of an interface between the liquid crystal layer and the polymer structure have at least one direction of a director different from the alignment direction by the alignment layer.

A¹-O—R¹—O—Z—O—R²—O-A² Formula (1)

wherein each of A¹ and A² is independently a curable functional group to be polymerized by an external energy, each of R¹ and R² is independently selected from a linear alkylene group with carbon number of 2 to 5 which may have a methyl group or an ethyl group as a branched chain, and Z is a bivalent mesogen structure.

According to the present invention, a liquid crystal optical device excellent in the reliability and its production process can be provided.

### BRIEF DESCRIPTION OF DRAWINGS

FIG. 1A is a cross-sectional view schematically illustrating a liquid crystal display device according to a first embodiment when a voltage is not applied.

FIG. 1B is a cross-sectional view schematically illustrating a liquid crystal display device according to a first embodiment when a voltage is applied.

FIG. 1C is a view schematically illustrating the alignment direction of liquid crystal.

FIG. 2A is a view schematically illustrating a substantial part of a liquid crystal display device when a voltage is not applied before a curing procedure.

FIG. 2B is a view schematically illustrating a substantial part of a liquid crystal display device when a voltage is not applied after a curing procedure.

FIG. 3 is a cross-sectional view schematically illustrating a liquid crystal light control device according to a second embodiment when a voltage is applied.

FIG. 4 is a graph obtained by plotting change of the shear storage modulus relative to the time for irradiation of ultraviolet light with respect to compositions in Examples and a Comparative Example.

FIG. 5 is a graph obtained by plotting the degree of curing relative to the time for irradiation of ultraviolet light with respect to compositions in Examples and a Comparative Example.

FIG. 6 is a graph obtained by plotting AT/Ti relative to applied voltages before and after evaluation for the reliability.

### DETAILED DESCRIPTION OF PREFERRED EMBODIMENTS

The liquid crystal optical device of the present invention is a liquid crystal optical device comprising a pair of substrates with electrodes provided thereon, a liquid crystal layer sandwiched between the substrates, an alignment layer to align the liquid crystal, and a polymer structure to control the alignment of the liquid crystal molecules of the liquid crystal phase provided on the alignment layer. The polymer structure applicable in the present invention will be described in detail below. Now, one example of an embodiment to which the present invention is applied will be described. It should be understood that another embodiment is included in the present invention so long as it is within the scope of the present invention. Further, the size and the proportion of the respective members in the drawings are for convenience of explanation and are different from actual ones.

### First Embodiment

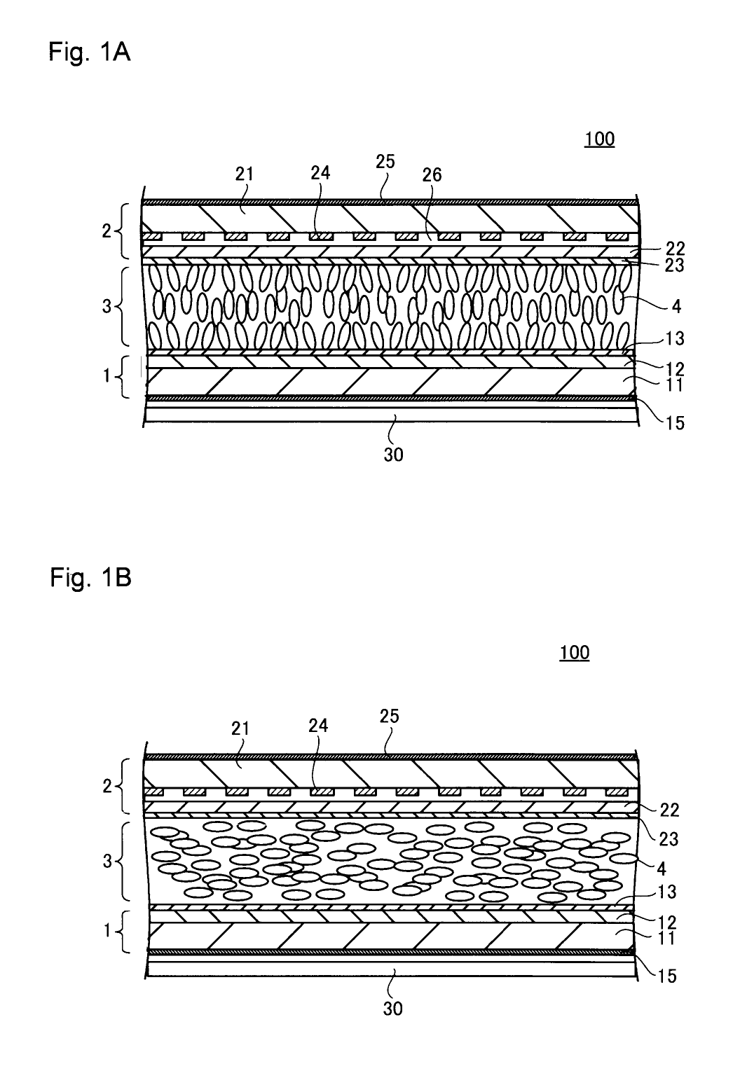

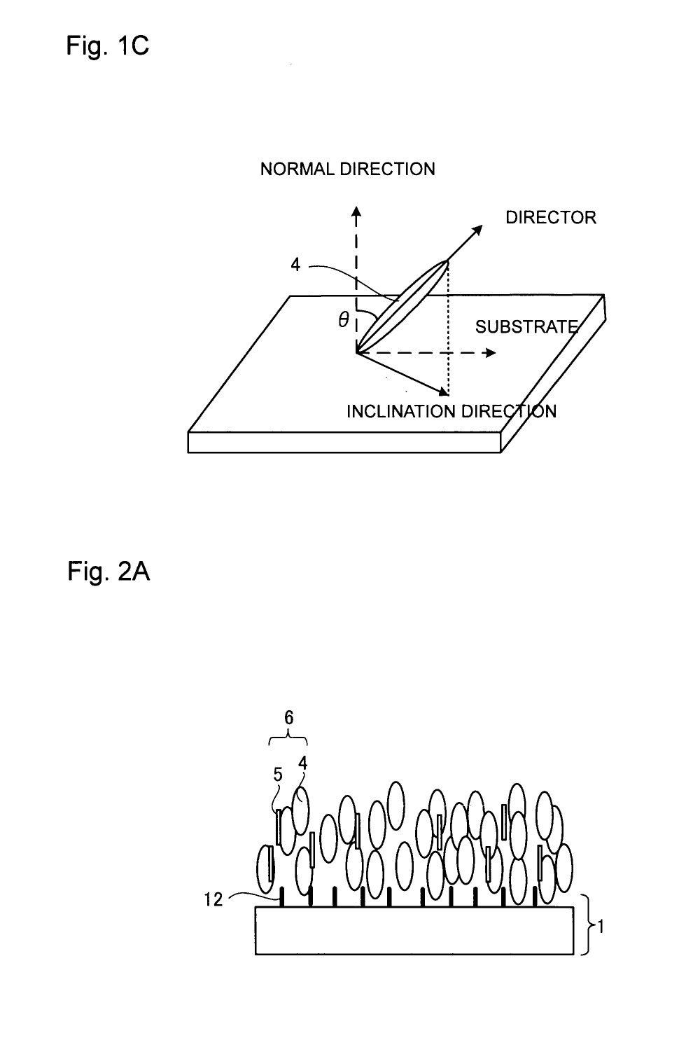

As a liquid crystal optical device according to a first embodiment, one example of a VA (Vertical Alignment) mode active matrix type liquid crystal display device will be described. FIG. 1A is a cross-sectional view schematically illustrating a substantial part of a liquid crystal display device according to the first embodiment when a voltage is not applied, and FIG. 1B is a cross-sectional view schematically illustrating a substantial part when a voltage is applied. Further, FIG. 1C is a view schematically illustrating the alignment of liquid crystal. Here, a transmission type liquid crystal display device will be described. Instead of the transmission type, a reflection type or semi-transmission type liquid crystal display device may also be used. Further, the device is also applicable to a passive type instead of an active matrix type.

A liquid crystal display device 100 has a pair of a first substrate 1 (e.g. a TFT substrate) and a second substrate 2 (e.g. a color filter substrate) with an electrode. Both the substrates are bonded by a sealing material (not shown) formed around the periphery of the substrates, and a liquid crystal layer 3 is sealed in a space surrounded by the sealing material, the first substrate 1 and the second substrate 2. The pair of substrates is held to have a predetermined distance by spherical spacers (not shown), columnar spacers or wall-form spacers as in-plane spacers. Further, “the electrode” may be provided only on either one of the substrates.

The first substrate 1 comprises a support substrate 11 which is an optically transparent glass substrate, a resin substrate or a combination thereof, or the like. On the surface in contact with a liquid crystal layer 3 of the first substrate 1, an alignment layer 12 to align liquid crystal of the liquid crystal layer 3 is formed. On the alignment layer 12, a polymer structure 13 is provided. On the outer surface of the support substrate 11, a polarizer 15 is provided. In an underlayer of the alignment layer 12, a pixel electrode (not shown) to apply a voltage to drive the liquid crystal, a switching element (not shown) such as TFT to supply a voltage to the pixel electrode, a wiring (not shown) to supply signals to the switching element, etc. are provided. The pixel element is provided, for example, by a transparent electrically conductive thin membrane of e.g. ITO (indium tin oxide), and an electrode in the form of a slit or an opening in the form of a slit is provided.

The second substrate 2 comprises a support substrate 21 which is an optically transparent glass substrate or the like. Either one of the support substrates 11 and 21 may be a reflecting electrode of aluminum or a dielectric multilayer film. On the surface in contact with the liquid crystal layer 3 of the second substrate 2, an alignment layer 22 to align liquid crystal of the liquid crystal layer 3 is provided, and on the alignment layer 22, a polymer structure 23 is provided. On the outer surface of the support substrate 21, a polarizer 25 is provided. With respect to the polarization axis of the polarizer 25 and the polarization axis of the polarizer 15, usually it is possible to employ a pair of polarizers laminated so that at least part of light transmitted through one polarizer is absorbed in the other polarizer when a voltage is not applied to the liquid crystal display device. There may be a case where the polarizers are laminated so that the polarization axis of the polarizer 25 and the polarization axis of the polarizer 15 are at right angles to each other.

In an underlayer of the alignment layer 22, a counter electrode 24 to apply an electric field to a space with the pixel electrode provided on the first substrate 1 to drive the liquid crystal is provided. Under the counter electrode 24, a color filter layer (not shown), a light shielding layer (not shown) etc. are provided. The counter electrode 24 has an opening 26 in the form of a slit.

The alignment layers 12 and 22 according to the first embodiment are so-called vertical alignment layers to align the liquid crystal in the liquid crystal layer 3 in a vertical direction when a voltage is not applied. In a display region of the pair of substrates with the electrode, the alignment layers 12 and 22 are provided. The material of each of the alignment layers 12 and 22 is not particularly limited so long as the layer functions as a vertical alignment layer, and it may, for example, be polyimide, a silane compound having an alkyl group or a fluoroalkyl group, or an olefin compound. In view of the heat resistance and stiffness, it is preferred to use polyimide.

The polymer structure 13 is provided in the form of a film or a network on the alignment layer 12. The polymer structure 23 is also provided in the form of a film or a network on the alignment layer 23. Each of the polymer structures 13 and 23 enables-liquid crystal molecules in the vicinity of an interface between the liquid crystal layer 3 and the polymer structure to have at least one direction of a director different from the alignment direction by the alignment layers 12 and 22. In the first embodiment, by the polymer structures 13 and 23, the alignment of liquid crystal molecules in the vicinity of the interface between the liquid crystal layer and the polymer structure is stabilized in a direction tilted from the normal direction of the surface of substrate (see FIG. 1C),when a voltage is not applied. The “tilt” here means a slope of the director of the liquid crystal to the normal direction of the surface of substrate when the liquid crystal is macroscopically observed as an aggregate of liquid crystal molecules 4. Further, “in the form of a film or a network” is meant to include a network structure which does not constitute a film.

Each of the polymer structure 13 and 23 is formed by curing a curable compound represented by the following formula (1). By using the polymer structures 13 and 23 obtained by curing the curable compound of the following formula (1), it is possible to realize a function to reproduce stable alignment control (tilted from the normal direction of the surface of substrate) even after repeatedly driving by application of a voltage. Further, each of the polymer structure 13 and 23 is preferably a phase-separated cured material from the liquid crystal layer, in order to more securely regulate the alignment of the liquid crystal. The phase-separated cured material may contain part of the liquid crystal molecules, however, in the case that the content of liquid crystal molecules in the cured material is too high, the stability of the alignment regulation might be impaired due to e.g. a decrease in the elastic modulus of the cured material. In order to suppress the content of liquid crystal molecules in the cured material, the curable compound preferably shows no liquid crystalline property by itself. Further, within a range not to impair the properties, a gel structure having a cured material made of the curable compound of the following formula (1) molecular dispersed in the liquid crystal may be contained.

A¹-O—R¹—O—Z—O—R²—OA² Formula (1)

In the formula (1), each of A¹ and A² is independently a curable functional group to be polymerized by application of an external energy and is not particularly limited.

Preferred examples of the external energy include active light rays, heating and electron beams. They may be used alone or in combination. From a viewpoint of controllability, preferred is a method of polymerization by irradiation with active light rays. The active light rays may, for example, be ultraviolet rays or visible light. In view of a handling efficiency, it is preferred to employ ultraviolet rays.

Each of A¹ and A² may be preferably a curable functional group to be polymerized by an external energy, such as an acryloyl group, a methacryloyl group, a vinyl group or an allyl group. Among them, particularly preferred is an acryloyl group or a methacryloyl group, with a view to increasing a curing reactivity. Since the curable compound of the formula (1) is a bifunctional compound having two curable moieties, many of cured materials have a crosslinked structure, and their thermoplasitic property is suppressed. Accordingly, the alignment of the liquid crystal can be stably controlled in a wide temperature range. For polymerization of the curable moieties A¹ and A², usually a polymerization initiator is used.

Z is a mesogen structure. This mesogen structure is a moiety having an important role to align the liquid crystal and the curable compound in the liquid crystal composition described hereinafter. Further, it is a moiety having an important role to increase the elastic modulus of the polymer structure. The structure of Z which is the mesogen structure is not particularly limited so long as Z has these functions, and it may, for example, be preferably a 4,4′-biphenylene group or 4,4′-terphenylene group of which some or all of hydrogen atoms may be substituted by a methyl group or a halogen atom, or a 4,4′-bicyclohexylene group or 4,4′-cyclohexylene group of which some or all of hydrogen atoms may be substituted by a methyl group or a halogen atom, or a bivalent mesogen structure having phenylene groups, biphenylene groups, cyclohexylene groups or the like connected by means of an ester linkage or a carbonate linkage.

In the formula (1), each of R¹ and R² is independently selected from a C₂₋₅ linear alkylene group which may have a methyl group or an ethyl group as a branched chain. As preferred examples thereof, a linear alkylene group having no branched alkyl chain may be an ethylene group (dimethylene group), a propylene group (trimethylene group), a butylene group (tetramethylene group) or a pentylene group (heptamethylene group). An alkylene group having a branched alkyl chain may, for example, be a methylethylene group, a methylpropylene group, a dimethylpropylene group, a methylbutylene group, a dimethylbutylene group, a methylpentylene group, a dimethylpentylene group, a methylpentylene group, an ethylethylene group or an ethylpropylene group. Among them, the linear alkylene group having no substituent may, for example, be preferably an ethylene group, a propylene group, a butylene group or a pentylene group, and the alkylene group having a substituent may, for example, be preferably a methylethylene group or an ethylethylene group.

As particularly preferred examples of R¹ and R², compounds represented by the following formulae (2) and (3) may be mentioned.

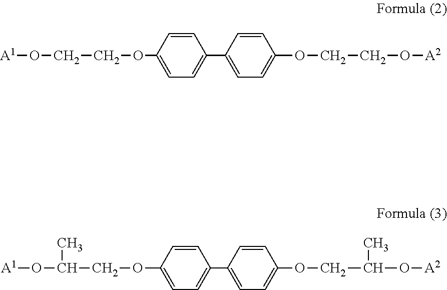

The above formula (3) is an example wherein R¹ and R² are a 1-methylethylene group, and a 2-methylethylene group in which the methyl group is bonded at the 2-position is also mentioned as a particularly preferred example. Further, a compound wherein each of R¹ and R² is independently selected from a 1-methylethylene group and a 2-methylethylene group may also be mentioned as a particularly preferred example. Further, as the curable compound, a mixture of at least two of the compound of the above formula (3), a compound corresponding to the above formula (3) wherein R¹ and R² are a 2-methylethylene group and the compound of the above formula (2) in an optional ratio may also be mentioned as a particularly preferred example.

In a case an linear alkylene group having a carbon number more than the above range is used as each of R¹ and R² in the formula (1), the molecular motion of a curable moiety during the curing will be improved, whereby the curing reactivity by irradiation with ultraviolet light can be improved. On the other hand, the elastic modulus of the cured material may be too low, whereby the stability of the alignment regulation of the liquid crystal may be insufficient. Further, if the branched chain bonded to the linear alkylene group as each of R¹ and R² is too bulky, the solubility of the curable compound to the liquid crystal may be impaired, or the elastic modulus of a cured material may be lowered. In a case that the elastic modulus of the cured material is low, the polymer structure itself which regulates the alignment direction of the liquid crystal molecules might be deformed due to an application of a voltage for a long time, whereby display deffect such as image sticking is likely to occur.

The liquid crystal display devie 100 is capable of applying an electric field in a direction vertical to the surface of substrate by the pixel electrode of the first substrate 1 and the counter electrode 24 of the second substrate 2. When a voltage is not applied, as shown in FIG. 1A, the director of the liquid crystal molecules in the vicinity of each of the interface between the liquid crystal layer 3 and the polymer structures 13 and 23 in the liquid crystal layer 3 are aligned slightly tilted from the normal direction of the surface of substrate. On the other hand, when a voltage is applied, as shown in FIG. 1B, liquid crystal molecules having a negative dielectric constant anisotropy in the liquid crystal layer 3 are aligned in a direction tilted in the horizontal direction to the surface of substrate. In such a manner, in accordance with the electric field applied between the substrates, the alignment of the liquid crystal is controlled.

The liquid crystal molecules in the vicinity of the interface between the liquid crystal layer and the polymer structures 13 and 23, are aligned in a tilted manner in a plurality of directions as observed from the surface of substrate by the opening 26 in the form of a slit and the pixel electrode in the form of a slit provided on the counter electrode 24. This is because when the curable compound of the above formula (1) is cured, the polymer structures 13 and 23 made of the cured material are provided while the alignment direction of a composition comprising the liquid crystal and the curable compound is controlled by applying a voltage, as described in detail in the after-mentioned production process. The tilted direction of the polymer structure which is obtained by curing the curable compound under an application of voltage is referred to as “the inclination direction of the polymer structure” in this specification, which is defined as a direction in which the long axis of mesogen structure for the polymer structure is projected on the surface of substrate. The inclination direction of the polymer structures 13 and 23 is not limited to the multi-direction, and an optional direction of e.g. one direction, two directions or four directions may be employed depending on the needs and the purpose of use. As a method of controlling the alignment direction of the composition comprising the liquid crystal and the curable compound in an uncured state, a well-known method may be employed without restriction. For example, alignment in the two directions, the four directions, the multi-direction or the like is possible by multi-rubbing comprising rubbing treatments in different directions combined, by irradiation of the alignment layer by photo-alignment with polarized light or by pattern irradiation, in addition to using the above-described electrode in the form of a slit or the opening in the form of a slit. Further, alignment in the multi-direction can be also provided by protrusions on the substrate.

By providing the polymer structures 13 and 23 obtained by curing the curable compound of the above formula (1) according to the first embodiment, the direction (see FIG. 1 C) of the director of the liquid crystal molecules in the vicinity of each of interface between the liquid crystal layer 3 and the polymer structures 13 and 23 when a voltage is not applied can be made to the multi-direction as observed from the surface of substrate. In this specification, the “direction of the director of the liquid crystal molecules” means a direction when the director of the liquid crystal molecules is projected on the surface of substrate.

By providing the polymer structures 13 and 23 obtained by curing the curable compound of the above formula (1) according to the first embodiment on the alignment layers 12 and 22, the direction of the director of the liquid crystal molecules when a voltage is applied can be made to be the multi-direction as observed from the surface of substrate. As a result, display properties in a wide viewing angle can be realized. As a means to make the direction of the director of the liquid crystal molecules when a voltage is applied be a multi-direction as observed from the surface of substrate, an example wherein an electrode in the form of a slit or the slit-opening (hereinafter they will sometimes be referred to as “e.g. an electrode in the form of a slit”) is used has been described. However, a known method can be used without restriction within a range not to depart from the scope of the present invention. For example, a protruded structure may be used instead of e.g. the electrode in the form of a slit or in combination with e.g. the electrode on the counter substrate in the form of a slit.

Now, one example of the process for producing the liquid crystal display device 100 according to the first embodiment will be described. However, it should be understood that the present invention is by no means restricted to the following production process, and various modifications are possible within a range not to depart from the scope of the present invention.

First, a pair of substrates with an transparent ITO (Indium Tin Oxide) electrode is prepared. Then, in an alignment layer providing step, an alignment layer is provided on the ITO substrates. The method of forming the alignment layer is not particularly limited, and a known method may be employed. For example, a coating film comprising an organic film is formed e.g. by a printing method, and is dried by e.g. an infrared furnace or a hot plate.

Then, the pair of substrates are bonded by means of a sealing material coating step, a spacer dispersing step, and the like. The distance between the substrates is not particularly limited, and is at a level of from 2 to 50 μm for example. Then, the liquid crystal composition is injected into the above described cell, and a inlet is sealed. Otherwise, the liquid crystal composition is dropped in several points on a surface of substrate surrounded by a sealing material, which is applied in a peripheral portion of the substrate. The substrate and a counter substrate having spacers preliminarily provided on a facing surface are bonded by means of the sealing material in vacuum, and then the sealing material is cured to obtain a laminated member having the liquid crystal composition sandwiched.

The liquid crystal composition contains liquid crystal having a negative dielectric constant anisotropy and a curable compound represented by the formula (1). As the liquid crystal, a nematic liquid crystal, a smectic liquid crystal, a choresteric liquid crystal, a ferroelectric liquid crystal may, for example, be used. The liquid crystal may be constituted by a single compound or may be a mixture of two or more compounds. In the case of a mixture, one having a negative dielectric constant anisotropy as the entire liquid crystal is used. The absolute value of the dielectric constant anisotropy is preferably larger with a view to decreasing the driving voltage. As a liquid crystal compound having a large value of the dielectric constant anisotropy, a compound having a cyano group or a halogen atom such as fluorine or chlorine as a substituent is used in view of a chemical stability. Some liquid crystal compounds having a cyano group have a great dielectric constant anisotropy. Further, a liquid crystal compound having a fluorine atom as a substituent has a high resistivity and is preferably used for driving by an active element such as TFT. To the liquid crystal composition, a polymerization initiator may be added so as to accelerate the curing reactivity of the curable compound. To the liquid crystal composition, other additives such as a chiral agent may properly be added within a range not to depart from the scope of the present invention.

It is preferred to provide the polymer structures 13 and 23 on the surface of the alignment layers 12 and 22. If the content of the curable compound is too high, the polymer structure after curing may be formed not only on the surface of the alignment layer but also in the entire liquid crystal layer 3 between the substrates in some cases, and will have influences over the alignment of the liquid crystal at a center portion between the substrates, thus leading to a decrease in the display contrast. On the other hand, if the content of the curable compound is too low, no homogeneous polymer structure will be formed on the surface of the alignment layer, and no sufficient effect of regulating the alignment of the liquid crystal will be obtained. With a view to stably forming the polymer structures 13 and 23 suitable for regulating the alignment of the liquid crystal, the curable compound is contained preferably in an amount of at least 0.1 mass % but no more than 5 mass % based on the total amount of the liquid composition. The content of the curable compound is more preferably at least 0.2 mass % but no more than 2 mass %, further preferably at least 0.2 mass % but no more than 1 mass %.

The liquid crystal composition comprising the liquid crystal and the uncured curable compound may contain a plural types of the curable compounds of the above formula (1) in order to improve the curing reactivity or to adjust the elastic modulus of the cured material. For example, it may contain two or more types of curable compounds with different numbers of carbon linkages in R¹ and R².

The liquid crystal composition of the liquid crystal and the uncured curable compound is preferably a homogeneous solution after mixing. Further, the liquid crystal composition of the liquid crystal and the uncured curable compound is preferably one showing a liquid crystalline state when sandwiched between the pair of substrates, whereby the alignment control is easily carried out.

In a case where a curing is carried out by irradiation with active light rays, as the polymerization initiator, a photopolymerization initiator to be commonly used for a photocurable resin, such as a benzoin ether type, an acetophenone type or a phosphine oxide type may be used. On the other hand, in the case of heat curing, a polymerization initiator of e.g. a peroxide type, a thiol type, an amine type or an acid anhydride type may be used depending on the type of the curable moiety, and as the case requires, a curing aid such as an amine may be used. The content of the polymerization initiator is preferably at most 20 mass % based on the uncured curable compound contained, and in a case where a high molecular weight or a high resistivity is required for a cured material after curing, the content is preferably at least 0.1 mass % but no more than 10 mass %, more preferably at least 0.5 mass % but no more than 5 mass %.

Then, in the curing, an external energy is applied while a voltage to control the alignment direction of the liquid crystal composition is applied. By changing the applied voltage level, the alignment direction of the liquid crystal composition is controlled to a desired direction.

The curable compound is cured in a state where the alignment of the liquid crystal composition is controlled. As the external energy, irradiation with active light rays, irradiation with electron beams, heating and the like may be used alone or in combination. From a viewpoint of the handling efficiency, irradiation with active light rays is preferred, and e.g. ultraviolet rays are suitably used. Further, it is possible to combine irradiation with active light rays and curing by heating.

In a case where the curable compound is cured by irradiation with active light rays to obtain a polymer structure, it is possible to use, as a light source, a high pressure mercury lamp, a low pressure mercury lamp, a metal halide lamp, a chemical lamp or the like.

In a case where the curable compound is cured by irradiation with active light rays, a light irradiation conditions are set depending on the types of the curable compound and the photopolymerization initiator to be added. The light irradiation intensity is preferably from 0.1 to 100 mW/cm². If it is less than 0.1 mW/cm², the curing rate will be low, and a long irradiation time will be required to form the polymer structure. Further, if it exceeds 10 mW/cm², a decomposition and deterioration of the liquid crystal may be induced.

A temperature when the liquid crystal composition comprising the liquid crystal and the uncured curable compound is cured by light irradiation is preferably within a temperature range within which the liquid crystal composition shows a uniform liquid crystalline state. In a case that the liquid crystal composition is cured at a lower temperature than temperature in which the liquid crystal composition shows an uniform state as a solution, some components might segregate from the solution before curing, whereby no homogeneous polymer structure might be obtained. Further, in a case where the curing is carried out at a temperature in an isotropic state, the liquid crystal alignment can not be controlled by application of a voltage, and the alignment direction of the liquid crystal composition might not be controlled to a desired direction. In a case where the liquid crystal composition is cured by photo-curing, the liquid crystal composition preferably shows a liquid crystalline state, and in the case of heat curing, it preferably shows a liquid crystalline state at the curing temperature.

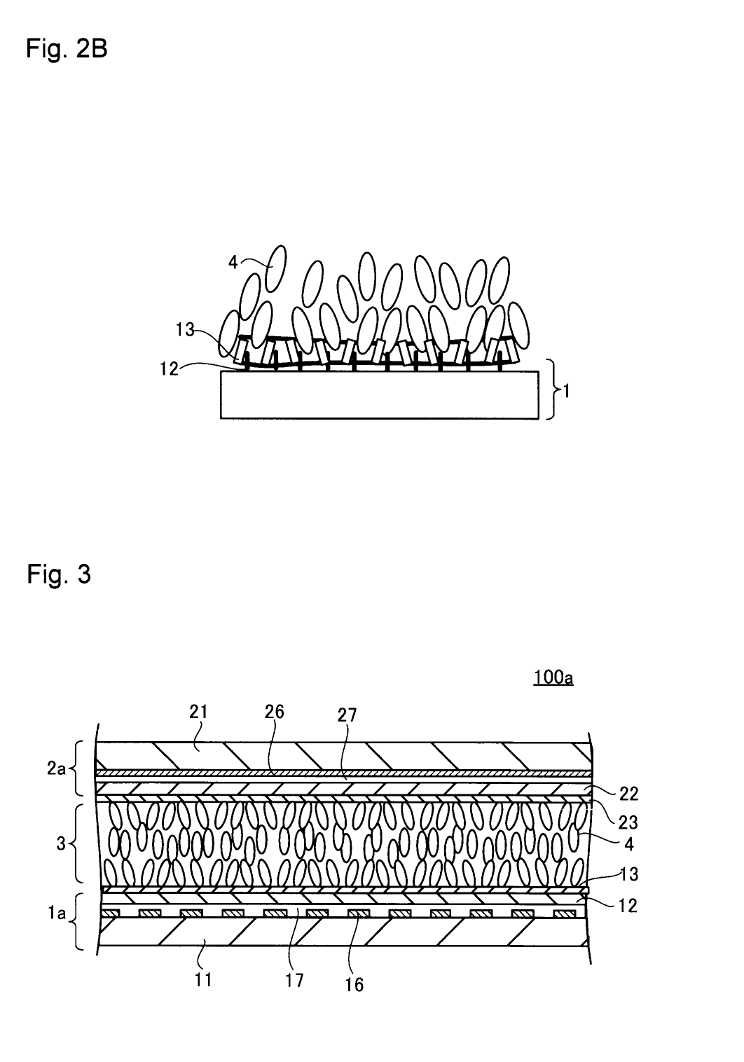

FIG. 2A is a view schematically illustrating a substantial part of a liquid crystal display device when a voltage is not applied before a curing procedure. FIG. 2B is a view schematically illustrating a substantial part of a liquid crystal display device when a voltage is not applied after a curing procedure. In a liquid crystal composition 6 before a curing procedure, liquid crystal and an uncured curable compound 5 are compatible with each other. By application of a predetermined voltage, an electric field in a direction perpendicular to the surface of substrate generates between the first substrate 1 and the second substrate 2, and the liquid crystal is aligned in a direction tilted from the normal of the substrate 1 in accordance with the applied voltage level. Therefore, the uncured curable compound 5 is also aligned so that its molecular long axis is in the same direction as the director of the liquid crystal molecule due to the interaction of the ring structure (mesogen structure) in the curable compound structure. When the curable compound 5 is cured by applying an external energy, each of polymer structures 13 and 23 is provided on each of alignment layers 12 and 22 as shown in FIG. 2B. By providing the polymer structures 13 and 23, the director of the liquid crystal molecules in the vicinity of each interface between the liquid crystal layer 3 and the polymer structures 13 and 23 are stabilized as tilted in a direction different from the alignment direction of the liquid crystal by the alignment layer 12 or 22. In the VA mode according to this embodiment, the director of the liquid crystal molecules in the vicinity of interface between the liquid crystal layer and the polymer structure align in a multi-direction relative to the normal direction of the surface of substrate, and the alignment is stabilized in a predetermined direction when a voltage is not applied. Thus, the alignment change direction can be regulated (memorized) when the alignment torque is applied on the liquid crystal molecules by application of a voltage, whereby a liquid crystal display device stably showing wide viewing angle properties and favorable response speed properties can be provided.

By controlling the voltage level to be applied at the time of the curing reaction, the alignment direction of the liquid crystal molecules in the vicinity of each interface between the liquid crystal layer 3 and the polymer structures 13 and 23 (in the VA mode according to this embodiment, a tilt angle of the liquid crystal molecules relative to the normal direction of the surface of substrate) can be adjusted. The preferable applied voltage level at the curing reaction is slightly higher than a threshold voltage of the uncured liquid crystal composition. In a case that the applied voltage is too lower than the threshold voltage, the polymer structure 13 or 23 may not be provided with a preferred angle of inclination. On the other hand, if the applied voltage is too higher than the threshold voltage, the tilt angle of the liquid crystal molecules in the vicinity of the interface between the liquid crystal layer 3 and the polymer structure 13 or 23 might become too large, whereby the incident light will undergo optic modulation when a voltage is not applied, and light will leak out from a polarizer provided in a light shielding state, thus leading to a decrease in a contrast of the liquid crystal display device.

Then, polarizers 15 and 25 are laminated to the liquid crystal cell. By means of a step of mounting e.g. a control board, a liquid crystal display panel is completed. The liquid crystal display panel is provided with a backlight unit 30 and is accommodated in a chassis to complete a liquid crystal display device 100.

In a case where a film substrate is used as the support substrate, it is possible to a method that continuously supplied substrates provided with electrodes are sandwiched between e.g. two rubber rolls, a liquid crystal composition of liquid crystal and an uncured curable compound, having spacers dispersed therein, is supplied and sandwiched between them, followed by continuous curing. Further, as a method of injecting the liquid crystal composition, ODF (One Drop Filling) method may be employed instead of the above method. In such a case, a predetermined amount of a liquid crystal composition is dropped on the inner surface of either of the pair of substrates, and is bonded with other substrate by a sealing material in vacuum condition, followed by returning the environmental pressure to the atmospheric pressure. In this case, curing of the sealing material and curing of the liquid crystal composition may be carried out simultaneously.

According to extensive studies by the present inventors, it was found that by using a curable compound represented by the above formula (1) with a small number of carbon linkages between the mesogen structure and each of the curable functional group, it is possible to provide a liquid crystal optical device which shows good display performance and high reliability even after use for a long time.

With respect to the liquid crystal display device according to the first embodiment, by providing the polymer structures 13 and 23, the director of the liquid crystal molecules in the vicinity of each interface between the liquid crystal layer 3 and the polymer structures 13 and 23 is stabilized in a direction different from the alignment direction which given by each of the alignment layer 12 and 22. Further, by the polymer structures 13 and 23, the alignment change direction of the liquid crystal when a voltage is applied can be regulated (memorized) to a predetermined direction, whereby it is possible to improve the viewing angle and the response speed.

With a photosensitive monomer which has an in-plane condensed poly-ring structure as a hard core of the above formula (C) in the above Patent Document 5, an absorption coefficient in a ultraviolet region and in a short wavelength visible region increases as a number of rings bonded increases, and thus a liquid crystal molecules may undergo deterioration such as decomposition by UV irradiation for curing. Decomposition of the liquid crystal molecules will lead to a decrease in the resistivity, and at a liquid crystal driving by an active element such as TFT, a decrease in the voltage retention may occur, thus leading to a decrease in the contrast.

On the other hand, with the curable compound of the above formula (1) according to the first embodiment, an increase in the absorption coefficient in the ultraviolet region and in the short wavelength visible region as mentioned above can be increased and in addition, the curable compound can be relatively easily synthesized by a known method. Further, by using the compound of the above formula (1) as the curable compound, compatibility to the liquid crystal can be increased, whereby the alignment direction of the liquid crystal composition can be controlled stably by means of applying a voltage when the curing.

Further, each of the polymer structure 13 and 23 according to the first embodiment is tilted in at least one direction to the normal direction of the surface of substrate in a state where a voltage is not applied, the alignment change direction of the liquid crystal when a voltage is applied can be securely regulated, whereby the response properties can be improved as compared with a conventional liquid crystal display device of which the alignment direction is controlled only by a vertical alignment layer.

In the above Patent Document 4, in the curable compound, the curable functional groups and the ring structure are directly bonded. Accordingly, the molecular motion at the curable functional group moiety will be restricted due to a stiffness and a steric bulkiness of the ring structure, and the curing reactivity might be impaired. Due to its low curing reactivity, the unreacted curable compound is easy to remain in the liquid crystal layer after curing. It will induce a change of the alignment direction and an image sticking by application of a voltage for a long time, thus leading to a deterioration in the display performance. Further, a high energy irradiation of ultraviolet rays for curing is required in some cases to suppress remaining of a uncured curable compound and a unreacted curable functional moieties, whereby decomposition and deterioration of the liquid crystal molecules might be induced. Further, with respect to the polymer structure after curing, as the molecular weight between crosslinked sites is remarkably low, a large amount of the uncured curable compound and the unreacted curable functional moieties remain in the polymer structure by steric hindrance of its ring structure in the curing procedure, whereby the polymer structure may be deformed over time, or the elastic modulus of the polymer structure after curing becomes too high, and the polymer structure cannot tolerate a subtle deformation and is fragile.

On the other hand, the curable compound of the above formula (1) according to the first embodiment, by introducing a C₂₋₅ linear alkylene group which may have a methyl group or an ethyl group as a branched chain, between the mesogen structure Z and each of the curable functional groups represented by A¹ and A² by means of an O atom, the molecular motion of the cured moiety can be increased, and the reactivity at the time of curing can be improved, whereby an amount of energy required for curing can be reduced. Further, since remaining of the uncured curable compound and the unreacted curable functional group moiety can be reduced, the regulated alignment direction of the liquid crystal molecules can be favorably maintained even after a use for a long time, and deterioration of the display performance such as image sticking, can effectively be prevented.

According to the liquid crystal display device according to the first embodiment, by introducing a C₂₋₅ linear alkylene group which may have a methyl group or an ethyl group as a branched chain, between the mesogen structure Z and each of the curable functional groups represented by A¹ and A² by means of an O atom in the above formula (1), the molecular motion of the curable moiety can be increased, and aldo the reactivity at the time of curing can be improved. In a case that the number of carbon linkages in the alkylene group is too many, the molecular weight between crosslinked moieties will be high, whereby the elastic modulus of the polymer structures will be lowered. Further, by introducing a C₂₋₅ linear alkylene group which may have a methyl group or an ethyl group as a branched chain, between the mesogen structure Z and each of the curable functional groups (A¹ and A²) by means of an O atom, the polymer structures after curing can maintain elasticity even against microdeformation, and deterioration of the display performance such as an image sticking can be prevented, whereby a highly reliable liquid crystal display device even after use for a long time can be provided.

### Second Embodiment

As a liquid crystal optical device according to a second embodiment, one example of a liquid crystal light control device will be described. In the following drawings, to the same components as in the above first embodiment, the same symbols are attached and their description is omitted.

FIG. 3 is a cross-sectional view schematically illustrating a substantial part of a liquid crystal light control device according to a second embodiment when a voltage is not applied. A liquid crystal light control device 100a according to the second embodiment is in a transparent state when a voltage is not applied and is in a uniformly light scattering state when a voltage is applied.

The liquid crystal light control device 100a comprises, as shown in FIG. 3, a transparent first substrate 1a and a transparent second substrate 2a disposed to face each other. Both the substrates are bonded by means of a sealing material (not shown) provided on the periphery of the pair of substrates, and a liquid crystal layer 3 is sealed in a space surrounded by the sealing material, the first substrate 1 a and the second substrate 2a. The first substrate la and the second substrate 2a are held with a predetermined distance by spherical spacers (not shown), columnar spacers or wall-like spacers as in-plane spacers. Either of the first substrate and the second substrate may be made of an opaque material. Further, each of support substrates 11 and 21 thereof may be a flat plate or may have a curvature on the whole area or on part thereof.

The first substrate 1a has a transparent support substrate 11. On the surface of the support substrate 11 which faces the second substrate 2a, a first electrode 16 comprising a transparent electroconductive film of e.g. ITO, and an insulating film 17 are provided. As the uppermost layer of the first substrate 1a, an alignment layer 12 is provided. On the alignment layer 12, a polymer structure 13 and the like are provided in the same manner as in the first embodiment.

The second substrate 2a has a transparent support substrate 21. On the surface of the support substrate 21 which faces the first substrate 1a, a second electrode 26 comprising a transparent electroconductive film of e.g. ITO to drive the liquid crystal, and an insulating film 27 are provided. As the outermost layer of the second substrate 1a, an alignment layer 22 is provided. On the alignment layer 22, a polymer structure 23 is provided in the same manner as in the first embodiment.

The first electrode 16 and the second electrode 26 are provided in stripes or on the whole area, and are provided in directions at right angles with each other. Either one of the first electrode 16 and the second electrode 26 may be a reflecting electrode of Al or a dielectric multilayer film. The shape of the electrode is merely one example, and the electrode may be provided on the whole area of the surface of substrate, or may have an electrode shape capable of displaying a specific mark or character. The first electrode 16 and the second electrode 26 are covered with an insulating film (not shown).

The liquid crystal optical device 100a has a flat shape but depending on the purpose of use, it may have a curvature on the whole area or a part thereof. That is, it may have a three-dimensional shape. However, in this case also, the distance between inner surfaces of the first substrate 1a and the second substrate 2a, i.e. the thickness (cell gap) of the liquid crystal layer 3 is substantially constant.

According to the liquid crystal light control device 100a according to the second embodiment, the polymer structures 13 and 23 obtained by curing the curable compound of the above formula (1) are provided on the alignment layers 12 and 22, whereby the same effects as in the above first embodiment can be obtained.

The above embodiments were described with respect to a liquid crystal display device and a liquid crystal light control device, but the present invention can be applied to general liquid crystal optical devices such as a liquid crystal optical shutter. Further, the present invention is not limited to the VA mode according to the above embodiments, and can be applied to the general VA mode in the broad sense of the term. Further, the present invention can be applied to another mode such as a IPS (In-Plane Switching) mode, a TN (Twisted Nematic) mode, a STN (Super Twisted Nematic) mode, a FFS (Fringe Field Switching) mode or a OCB mode. Further, the above embodiments were described with reference to a vertical alignment layer as an alignment layer, but an preferable alignment layer can be selected depending on each mode. Further, the above embodiments were described with reference to an example wherein the direction of the director of the liquid crystal molecules in the vicinity of an interface between the liquid crystal layer and the polymer structure is tilted from the normal direction of the surface of substrate without an applied voltage, and this is for convenience of explanation. That is, the polymer structure according to the present invention is provided by curing the curable compound represented by the above formula (1), and may be one such that the liquid crystal molecules in the vicinity of the interface between the liquid crystal layer and the polymer structure has at least one direction of a director different from the alignment direction by the alignment layer, when a voltage is not applied. Further, in the above embodiment, the direction of the director of liquid crystal in the vicinity of the interface between the liquid crystal layer and the polymer structure is controlled by the polymer structure, but it is not excluded that the direction of the director of liquid crystal except in the vicinity of the interface between the liquid crystal layer and the polymer structure is controlled by the polymer structure.

Now, the present invention will be described in detail with reference to Examples. However, it should be understood that the present invention is by no means restricted to such specific Examples.

### EXAMPLE 1

An evaluation cell was prepared by the following method. Specifically, a polyimide thin layer for vertical alignment was formed on a clean ITO transparent electrode, and rubbing treatment was applied to the surface of substrate so as to impart a very fine pretilt angle, thereby to prepare a pair of substrates. Then, the substrates were bonded so that the polyimide thin layer formed on the surface of substrate faced each other to prepare the evaluation cell. The pretilt angle of the alignment layer of the liquid crystal cell was at most 0.5° when the pretilt angle in the direction vertical to the surface of substrate is 0°, and the cell gap was 2.7 μm.

Then, a nematic liquid crystal (Δε=−2.1, Δn=0.116, nematic-isotropic phase transition temperature=103.4° C., viscosity=18.8 mPa·s) having a negative dielectric constant anisotropy for VA-liquid crystal display, a curable compound represented by the formula (4) and benzoin isopropyl ether (BiPE, manufactured by TOKYO CHEMICAL INDUSTRY. CO., LTD.) as a polymerization initiator were mixed to prepare a uniform liquid crystal composition. The amount of the curable compound added was 0.5 mass % based on the total amount of the liquid crystal composition. Further, the amount of the polymerization initiator added was 1 mass % based on the amount of the curable compound added.

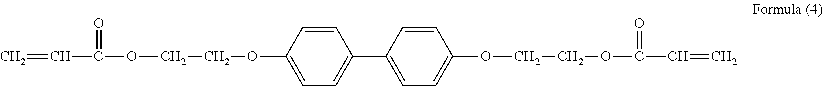

Then, the liquid crystal composition was injected in the evaluation cell by a vacuum injection method. The inlet was coated with a sealing agent for a liquid crystal cell, and then the evaluation cell was irradiated with ultraviolet light by means of a Hg—Xe lamp light source at a temperature of 25° C. while a voltage was applied between the facing substrates in the evaluation cell under conditions of 3 Vrms and 200 Hz. The threshold voltage of the liquid crystal composition was a value smaller than 3 Vrms. The evaluation cell was irradiated with an irradiation intensity of 3 mW/cm² at 365 nm at 25° C. for 10 minutes. Then, the liquid crystal cell was sandwiched between laminated a pair of polarizers so that a polarization axes are at right angles, while a angle formed by the rubbing direction of the polyimide thin membrane and the polarization axis was adjusted to be 45°. By means of such steps, a liquid crystal display device was obtained.

### EXAMPLE 2

A uniform liquid crystal composition was obtained by mixing the same liquid crystal as in Example 1, a curable compound represented by the formula (5) and the same polymerization initiator as in Example 1 in the same mixing ratio as in Example 1. Further, a liquid crystal display device was obtained in the same manner as in Example 1.

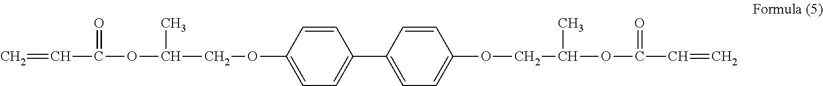

### COMPARATIVE EXAMPLE 1

A uniform liquid crystal composition was obtained by mixing the same liquid crystal as in Example 1, a curable compound (4,4′-bisacryloyloxybiphenyl) represented by the formula (B) and the same polymerization initiator as in Example 1 in the same mixing ratio as in Example 1. Further, a liquid crystal display device was obtained in the same manner as in Example 1.

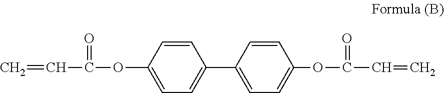

### COMPARATIVE EXAMPLE 2

A uniform liquid crystal composition was obtained by mixing the same liquid crystal as in Example 1, a curable compound represented by the following formula (D) and the same polymerization initiator as in Example 1 in the same mixing ratio as in Example 1. Further, a liquid crystal display device was obtained in the same manner as in Example 1.

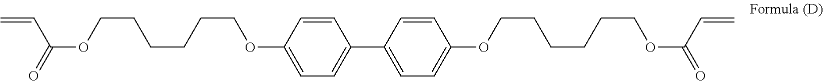

### COMPARATIVE EXAMPLE 3

A liquid crystal display device was prepared by using the same liquid crystal as in Example 1 without mixing a curable compound and a polymerization initiator. The preparation conditions were all the same as in Example 1.

### <Evaluation of Curing Reactivity of Resin>

Of the curable compounds in Examples 1 and 2 and Comparative Examples 1 and 2, the curing reactivity (polymerizability) by irradiation with ultraviolet light in a non-curable medium such as liquid crystal was evaluated by measuring a shear storage modulus (G′). The shear storage modulus was measured by a modular rheometer (manufactured by Anton Paar, Physica MCR 301).

A composition for evaluation of the curing reactivity was prepared by a following method. To N,N-dimethylformamide (DMF) (manufactured by TOKYO CHEMICAL INDUSTRY. CO., LTD.), 9 mass % of the curable compound in Example 1 and 1 mass % of a curable compound (manufactured by SHIN-NAKAMURA CHEMICAL CO., LTD., A-PTMG-65) represented by a following formula (E) were added. Further, benzoin isopropyl ether (BiPE manufactured by TOKYO CHEMICAL INDUSTRY. CO., LTD.) as a polymerization initiator was added in an amount of 1 mass % based on the total amount of the curable compound to prepare an evaluation composition. Then, the composition was dissolved with stirring with heating for 1 hour while the composition was maintained at 100° C. to obtain a uniform evaluation composition liquid containing the curable compound of Example 1. To evaluate curable compositions of Example 2 and Comparative Examples 1 and 2 in the same manner, uniform evaluation compositions were prepared in the same manner.

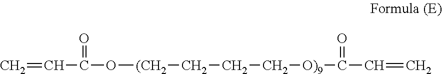

In this evaluation of curability, the solubility of the curable compound in Comparative Example 1 in the liquid crystal is so low as at most 2 mass % at room temperature, and it is difficult to prepare a specimen for measurement of the shear storage modulus by the modular rheometer because the low content of curable compound leads to a fragile cured material. Thus, a DMF solvent was used instead of liquid crystal as a non-curable medium. In other words, DMF was used as a common solvent to dissolve the curable compound in Comparative Example 1. Further, a cured composite material obtained from a DMF solution comprising the curable compound in Comparative Example 1 is very brittle since a molecular weight between crosslinked sites is low. It is difficult to measure a viscoelasticity because an applied strain for the measurement could deform a shape of the cured composite material structure. Accordingly, by adding the curable compound of the above formula (E) with which a relatively flexible cured composite material will be obtained, the evaluation composition with which the viscoelasticity can be measured was prepared.

The shear storage modulus (G′) was measured as follows. Each of the above evaluation composition liquids was sandwiched in a space (set to 0.4 mm) between a stage made of soda lime glass and a measurement spindle (manufactured by Anton Paar, D-PP12) and irradiated with ultraviolet light under conditions where the illuminance at a wavelength of 365 nm was 0.3 mW/cm² by an ultraviolet light source disposed below the stage. 1 Hz, 1% of dynamic shear strain was applied with an ultraviolet irradiation to measure the shear storage modulus (G′) relative to an ultraviolet light irradiation time. The shear storage modulus value shown after the ultraviolet light irradiation time of 1,200 seconds was regarded as a saturated shear storage modulus (G′max), and the shear storage modulus (G′) at each ultraviolet light irradiation time was standardized by G′max to calculate a degree of curing of each evaluation composition. From the respective evaluation compositions in Examples 1 and 2 and Comparative Examples 1 and 2, by the ultraviolet light irradiation, a film-form cured composite material containing DMF as a non-curable medium was obtained.

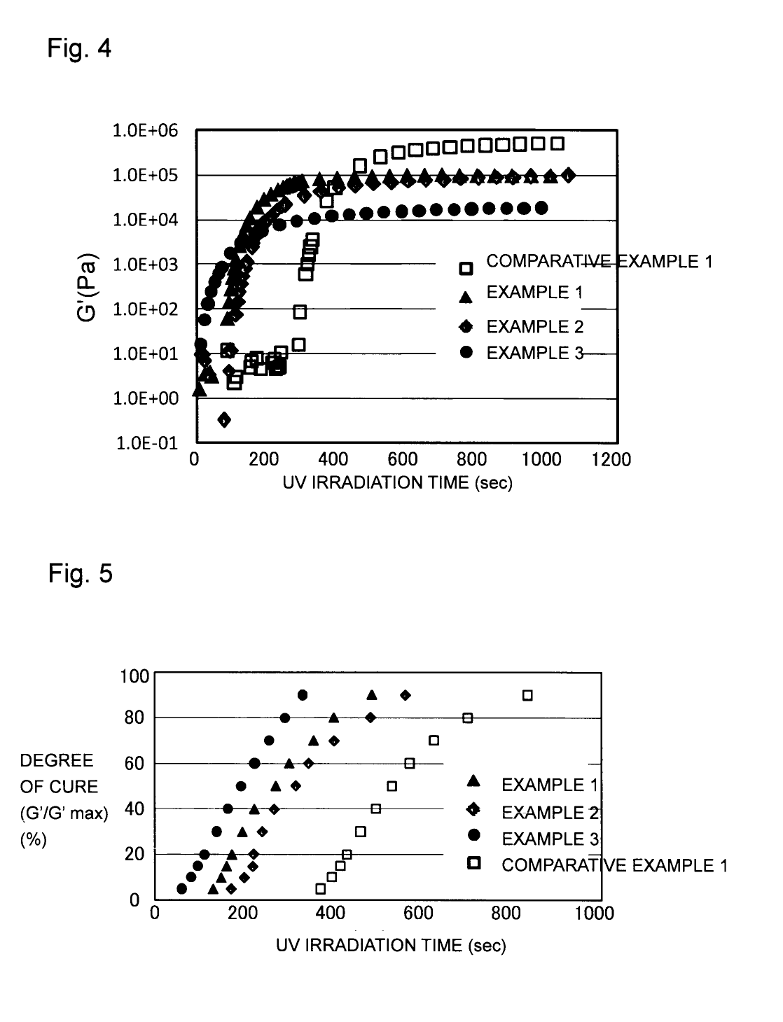

FIG. 4 is a graph obtained by plotting the change of the shear storage modulus relative to the ultraviolet light irradiation time with respect to the respective evaluation compositions. Further, in FIG. 5 is shown a graph obtained by plotting the degree of curing relative to the ultraviolet light irradiation time with respect to the respective evaluation compositions. The following founding was obtained from FIGS. 4 and 5.

With respect to the evaluation compositions in Examples 1 and 2 and Comparative Example 2, as compared with the evaluation composition in Comparative Example 1, at the initial stage of the ultraviolet light irradiation. an increase in the shear storage modulus due to progress of curing was observed, and the shear storage modulus reached a saturated value by irradiation in a shorter time. It is found from FIG. 5 that the polymerization reactivity is highest in Comparative Example 2, and the irradiation time with which the shear storage modulus reaches a saturated value at an early stage, is shortest. It is considered that the curing reactivity of the curable moiety is increased by introducing a relatively long linear C6 alkylene group between the mesogen structure and the curable functional group. It is suggested from FIGS. 4 and 5 that the spacer between the 4,4′-biphenylene group as the mesogen structure and the curable functional group (the acryloyloxy group in this Example) has a great influence over the curing reactivity and the saturated shear storage modulus (G′max). That is, it is suggested that the longer the spacer present between the mesogen structure and the curable functional group, the higher the characteristic of the molecular motion of the curable moiety, whereby the curing reaction proceeds by the ultraviolet light irradiation in a shorter time.

It is considered that in the curable compound in Comparative Example 1, the 4,4′-biphenylene group as the mesogen structure and the curable functional group are directly bonded, and accordingly the molecular motion of the cuable moiety is restricted, thus leading to a low curing reactivity.

With the evaluation composition in Example 1, the curing reactivity was slightly high as compared with the evaluation composition in Example 2. It is considered that, in the curable compound in Example 2, substituents corresponding to R¹ and R² are a methylethylene group, which is more bulky than an ethylene group. That is, it is considered that the molecular motion of the curable moiety is restricted due to bulkiness of branched methyl chain as compared with Example 1.

### (Evaluation of Pretilt Angle)

With respect to the liquid crystal display devices obtained in Examples 1 and 2 and Comparative Examples 1 to 3, the pretilt angle was measured. For the evaluation of pretilt angle, a crystal rotation method was employed. The pretilt angle was calculated by defining the normal direction to the surface of substrate to 0°. The results are shown in Table 1. The pretilt angle was evaluated by using the liquid crystal display device before laminating a polarizer.

TABLE 1

| Evaluation device | Pretilt angle |
|---|---|
| Example 1 | 1.0 |
| Example 2 | 0.8 |
| Comparative Example 1 | 0.8 |
| Comparative Example 2 | 0.9 |
| Comparative Example 3 | 0.4 |

It is evident from Table 1 that with respect to each of the liquid crystal display device in Examples 1 and 2 and Comparative Examples 1 and 2, the pretilt angle was bigger as compared with Comparative Example 3 in which the liquid crystal was injected by itself. That is, it is found that a liquid crystal display device was obtained such that the liquid crystal has a direction (pretilt angle) of a director different from the alignment direction (Comparative Example 3) by the alignment layer, by formation of the polymer structure on the alignment layer under application of voltage.

### (Evaluation of Response Speed)

Using the same sample as above, the response speed (ms: millisecond) in which an optical change was observed after application of a voltage was measured under 25° C. and the results are shown in Table 2. A saturated brightness of a liquid crystal display device when a voltage is not applied is regarded as a relative brightness 0%, and the saturated brightness when an optional voltage is applied is regarded as a relative brightness 100%. In Table 2, Rise means a time over which the relative brightness reaches 90% from 0% (a time over which a relative brightness change reaches 90% of the required change after a driving voltage is applied), and Decay in Table 2 means a time over which the relative brightness reaches 10% from 100% (a time over which the relative brightness change reaches 90% when a voltage is turned off from a voltage-applied state). Further, Total in Table 2 means the sum of Rise and decay. The driving voltage for evaluation was 6 V.

TABLE 2

| | | | Compara- | Compara- | Compara- |
|---|---|---|---|---|---|
| | Exam- | Exam- | tive | tive | tive |
| | ple 1 | ple 2 | Example 1 | Example 2 | Example 3 |
| Rise (ms) | 4.85 | 5.64 | 6.23 | 6.37 | 7.62 |
| Decay (ms) | 4.51 | 4.06 | 4.18 | 6.65 | 5.23 |
| Total (ms) | 9.36 | 9.70 | 10.41 | 13.02 | 12.85 |

With respect to each of the liquid crystal display device according to Examples 1 and 2 and Comparative Examples 1 and 2, Rise was improved as compared with the liquid crystal display device in Comparative Example 3 wherein liquid crystal was injected by itself, and it is remarkably improved particularly in Examples 1 and 2.

Further, with respect to Decay also, the response speed of the liquid crystal display devices in Examples 1 and 2 were improved as compared with the liquid crystal display devices in Comparative Example 1 to 3, and it was found that the polymer structure formed by the curable compound represented by the formula (1) suitably controls the alignment change direction of the liquid crystal when a voltage is applied.

The curable compound in Comparative Example 2 has a linear C6 alkylene group between the mesogen structure and the curable functional group, whereby the elastic modulus of the polymer structure obtained by curing tends to be low as compared with the polymer structure obtained by curing the curable compounds in Examples 1 and 2 and Comparative Example 1. Further, since the curing reactivity of the curable moiety is higher, the polymer structure containing a large amount of liquid crystal molecules might be formed after the curing. It is considered that Comparative Example 2 shows a slightly slow decay time because liquid crystal molecules contained in the polymer structure might impair the stabilization of liquid crystal alignment in its interface.

### (Evaluation for Reliability)

Each of the liquid crystal display device in Examples 1 and 2 and Comparative Examples 1 and 2 was held for 500 hours in a thermostatic chamber at about 80° C. in a state where a voltage of 10 Vrms at 100 Hz was applied (A Driving-Heat storage). A change in a transmittance properties relative to a applied voltages before and after the storage durability test was measured.

### (Optical Property Change)

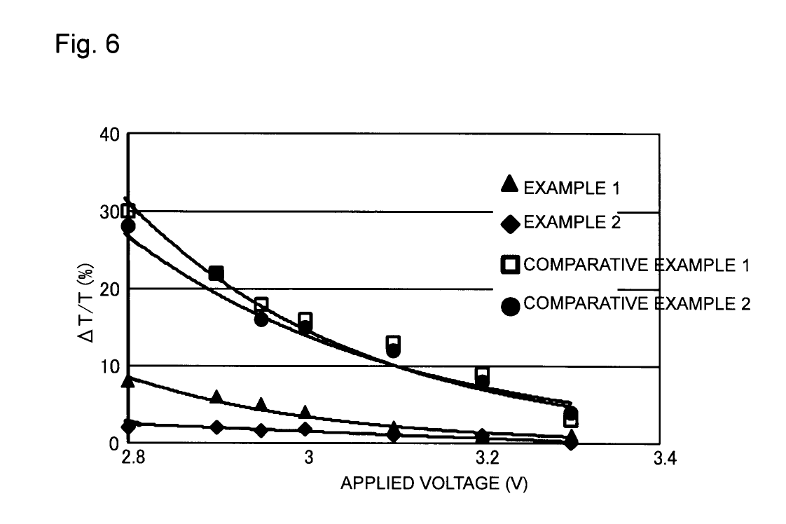

The change in the transmittance of the liquid crystal display device relative to the applied voltage between before and after the Driving-Heat storage is shown in FIG. 6. The change in the transmittance relative to the applied voltage was calculated by standardizing a difference (T−Ti) i.e. ΔT between the transmittance Ti before the Driving-Heat storage and the transmittance T after the Driving-Heat storage, by a initial transmittance Ti, i.e. ΔT/Ti. The closer ΔT/Ti to 0%, the smaller the change in the transmittance between before and after the Driving-Heat storage, that is, the better the reliability in the Driving-Heat storage.

From FIG. 6, with respect to each of the liquid crystal display device according to Examples 1 and 2, the change in the transmittance (ΔT/Ti) relative to the applied voltage was remarkably improved as compared with the liquid crystal display devices in Comparative Examples 1 and 2. Specifically, the liquid crystal display devices in Comparative Examples 1 and 2 show a high value of ΔT/Ti when a voltage of at most 3 V was applied, whereas the liquid crystal display devices in Examples 1 and 2 show ΔT/Ti close to 0. It is considered that the polymer structures in Comparative Examples 1 and 2 could not maintain a initial liquid crystal alignment (before the Driving-Heat storage) after the Driving-Heat storage, since the liquid crystal alignment during the Driving-Heat storage might deform the polymer structure. That is, it is considered that the director of the liquid crystal in the vicinity of the interface between the liquid crystal layer and the polymer structure was changed to increase T, whereby ΔT/Ti becomes a high value. With respect to the Driving-Heat storage, reliability was good in the liquid crystal display devices in Examples 1 and 2 as compared with the liquid crystal display devices in Comparative Examples 1 and 2.

The reason why the change in the transmittance (ΔT/Ti) relative to the applied voltage could be improved in the liquid crystal display devices in Examples 1 and 2 as compared with the liquid crystal display device in Comparative Example 1, is considered to be introduction of a favorable length alkylene group between the mesogen structure and the curable functional group by means of an O atom in the curable compound. In other words, by introduction of the favorable length alkylene group between the mesogen structure and each of the curable functional group, the curing reactivity of the curable compound is improved, and the unreacted curable compound remaining in the liquid crystal layer can be reduced. In addition, by controlling of the length of the alkylene group between the mesogen structure and each of the curable functional group, the elastic modulus of the polymer structure can be increased, and reliability under storage with an applied voltage can be improved.

### REFERENCE SYMBOLS

1: First substrate
2: Second substrate
3: Liquid crystal layer
4: Liquid crystal molecule
5: Curable compound
6: Liquid crystal composition
11: Support substrate
12: Alignment layer
13: Polymer structure
15: Polarizer
21: Support substrate
22: Alignment layer
23: Polymer structure
24: Counter electrode
25: Polarizer
30: Backlight unit
100: Liquid crystal display device
100a: Liquid crystal light control device

The entire disclosure of Japanese Patent Application No. 2011-085518 filed on Apr. 7, 2011 including specification, claims, drawings and summary is incorporated herein by reference in its entirety.

What is claimed is:

1. A liquid crystal optical device comprising a pair of substrates with electrodes; a liquid crystal layer sandwiched between the substrates; an alignment layer to align the liquid crystal, provided on each of the facing surfaces of the substrates; and a polymer structure provided on the alignment layer; wherein the polymer structure is formed by curing a curable compound represented by the following formula (1) while a voltage is applied, and when a voltage is not applied, liquid crystal molecules in the vicinity of an interface between the liquid crystal layer and the polymer structure have at least one direction of a director different from the alignment direction by the alignment layer:
A¹-O—R¹—O—Z—O—R²—O-A² Formula (1)
wherein each of A¹ and A² is independently a curable functional group to be polymerized by an external energy, each of R¹ and R² is independently selected from a linear alkylene group with carbon number of 2 to 5 which may have a methyl group or an ethyl group as a branched chain, and Z is a bivalent mesogen structure.

2. The liquid crystal optical device according to claim 1, wherein each of said A¹ and A² is independently any one of an acryloyl group, a methacryloyl group, a vinyl group and an allyl group.

3. The liquid crystal optical device according to claim 1, wherein a cured product of the curable compound is contained in an amount of at least 0.2 mass % but no more than 2 mass % based on the total amount of the liquid crystal and the curable compound.

4. The liquid crystal optical device according to claim 1, wherein the cured product of the curable compound makes the liquid crystal have at least two directions of a director.

5. The liquid crystal optical device according to claim 1, wherein each of said A¹ and A² is either an acryloyl group or a methacryloyl group, and each of said R¹ and R² is independently any one of a linear ethylene group, propylene group, butylene group or pentylene group, which may have a methyl group or an ethyl group as a substituent.

6. The liquid crystal optical device according to claim 1, wherein said Z is a 4,4′-biphenylene group of which some or all of the hydrogen atoms may be substituted by a methyl group or a halogen atom.

7. The liquid crystal optical device according to claim 1, wherein a pair of polarizers is provided on an outside surface of each of the substrates, and when a voltage is not applied, at least a part of light transmitted through one polarizer is absorbed in the other polarizer.

8. The liquid crystal optical device according to claim 1, wherein the alignment layer is a vertical alignment film, and the liquid crystal has negative dielectric constant anisotropy.

9. A process for producing a liquid crystal optical device, which comprises a step of forming an alignment layer to align a liquid crystal on each of facing surfaces of a pair of substrates having an electrode pair; a step of bonding the substrates each having the alignment layer formed and supplying a liquid crystal composition comprising a liquid crystal and a curable compound represented by the following formula (1) between the substrates; and a step of applying an external energy to carry out the curing reaction of the curable compound while a voltage is applied between the pair of substrates to control the alignment of liquid crystal composition to be in a desired direction, thereby to form a polymer structure on each alignment layer; wherein when a voltage is not applied, by the polymer structure, liquid crystal molecules in the vicinity of an interface between the liquid crystal layer and the polymer structure have at least one direction of a director different from the alignment direction by the alignment layer:
A¹-O—R¹—O—Z—O—R²—O-A² Formula (1)
wherein each of A¹ and A² is independently a curable functional group to be polymerized by the external energy, each of R¹ and R² is independently selected from a linear alkylene group with carbon number of 2 to 5 which may have a methyl group or an ethyl group, and Z is a bivalent mesogen structure.

10. The process for producing a liquid crystal optical device according to claim 9, wherein the curable compound is contained in an amount of at least 0.2 mass % but no more than 2 mass % based on the total amount of the liquid crystal composition.

11. The process for producing a liquid crystal optical device according to claim 9, wherein each of said A¹ and A² is independently either an acryloyl group or a methacryloyl group, and each of said R¹ and R² is independently any one of a linear ethylene group, propylene group, butylene group or pentylene group, which may have a methyl group or an ethyl group as a substituent.

12. The process for producing a liquid crystal optical device according to claim 9, wherein the external energy is active light rays.

13. The process for producing a liquid crystal optical device according to claim 9, wherein the liquid crystal composition further contains a curing agent catalyst which accelerates curing of the curable compound by application of the external energy.

14. A liquid crystal optical device produced by the process for producing a liquid crystal optical device as defined in claim 9.
